(19) United States
(12) Patent Application Publication
(10) Pub. No.: US 2005/0031272 A1
(43) Pub. Date: Feb. 10, 2005

(54) Enclosed optical circuits

(76) Inventors: Sam Leeman, Leuven (BE); Joris Franckx, Bonheiden (BE); Jan Watte, Grimbergen (BE); Walter Mattheus, Kessel-Lo (BE); Paul Meurs, Leuven (BE); Kathleen Bellekens, Winkasele-Delle (BE)

Correspondence Address: MYERS BIGEL SIBLEY & SAJOVEC, PO BOX 37428, RALEIGH, NC, 27627, US

(21) Appl. No.: 10/501,312

(22) PCT Filed: Jan. 9, 2003
(86) PCT No.: PCT/GB03/00059

(30) Foreign Application Priority Data
Jan. 18, 2002 (GB) 0201113.8

(51) Int. Cl. G02B 6/42; H05B 3/02

(52) U.S. Cl. 385/92; 219/243

(57) ABSTRACT

A device (1) for sealingly enclosing at least one optical circuit (10), the device comprising a container (3) and a humidity control means (4) accommodated in the container (3). The device is characterised by temperature control means (5, 6) arranged in the container (3). The container (3) is preferably flexible.

The present invention relates to enclosed optical circuits. More in particular, the present invention relates to a device and a method for sealingly enclosing at least one optical circuit.

It is well known that moisture has adverse effects on the properties of optical components. The split ratio of optical splitters, for example, may be influenced by the presence of moisture, and in filters and mirrors moisture may cause degrading of their optical characteristics. The sealing of optical components against moisture and other environmental influences, in other words environmental sealing, is therefore highly desirable.

It has been proposed to environmentally seal individual optical components. This is, however, relatively expensive and not always effective.

In the case of electrical or electronic components it is known to seal an entire circuit by enclosing it in a flexible, moisture-resistant bag. WO 94/18815 (Ericsson), for example, discloses a casing for flexibly enclosing electronic circuitry. The casing comprises a laminate consisting of metal and plastic sheets. Two sheets of laminate are joined to form an envelope in which electronic circuitry may be accommodated. Electrical conductors pass through the joint region of the laminate.

Although such an arrangement may be effective for sealing electronic circuits, it is less suitable for optical components or circuits. The present inventors have found that the performance of optical components and/or circuits can be significantly improved by providing a controlled environment, that is, an environment in which both the humidity and the temperature are controlled. Conversely, the failure rate of optical components and/or circuits can be significantly reduced by a suitably controlled environment.

It is known for a flexible container to contain a desiccant to control the moisture level within the container. The present invention seeks to improve the environment of optical circuits by providing a device for sealingly enclosing at least one optical circuit, the device comprising a container and a humidity control means accommodated in the container, characterised by temperature control means arranged in the container.

By providing temperature control means in addition to humidity control means (such as desiccant) a further reduction of the possibility of condensation within the device can be achieved, while in addition excessively high temperatures can be avoided.

The container is preferably substantially flexible but may also be substantially rigid, or some parts may be flexible while others are rigid.

The temperature control means may comprise a heat sink or a heat pipe, and/or an active temperature controller such as a heater (e.g. electrical) and/or an active cooling element. It will be understood that the container provides a moisture barrier and may be hermetically sealed. Preferably, the container provides a thermal barrier as well.

In first embodiment of the device according to the present invention, the temperature control means are accommodated in a wall of the container. To this end a cavity may be provided in the wall to accommodate the temperature control means.

In a second embodiment, the temperature control means are accommodated in a space defined by the container. That is, the temperature control means are located in the space where the optical circuit(s) is (are) located, preferably adjacent the optical circuit(s). Advantageously, the temperature control means are accommodated between the at least one optical component and a desiccant means.

In a third embodiment, at least two temperature control means are provided, one being located in a wall of the container and another in the space defined by the container. In this way, an even higher degree of temperature control can be achieved.

In a preferred embodiment the container comprises an insulating layer and a moisture barrier layer. The moisture barrier layer is preferably located on the inside of the container.

In a particularly advantageous embodiment the device has an opening for feeding optical fibres therethrough, said opening being sealed by sealing strips to which heat and/or pressure is applied, said sealing strips preferably being made of plastic. Such a sealing arrangement is described in British Patent Application GB 01 10366.2.

The present invention further provides a kit-of-parts for forming a device as defined above, and a method of sealingly enclosing at least one optical circuit, the method comprising the steps of providing a container, providing a humidity control means, providing a temperature control means and accommodating the at least one circuit, the humidity control means and the temperature control means in the container.

The invention will further be explained below with reference to the accompanying drawings, in which:

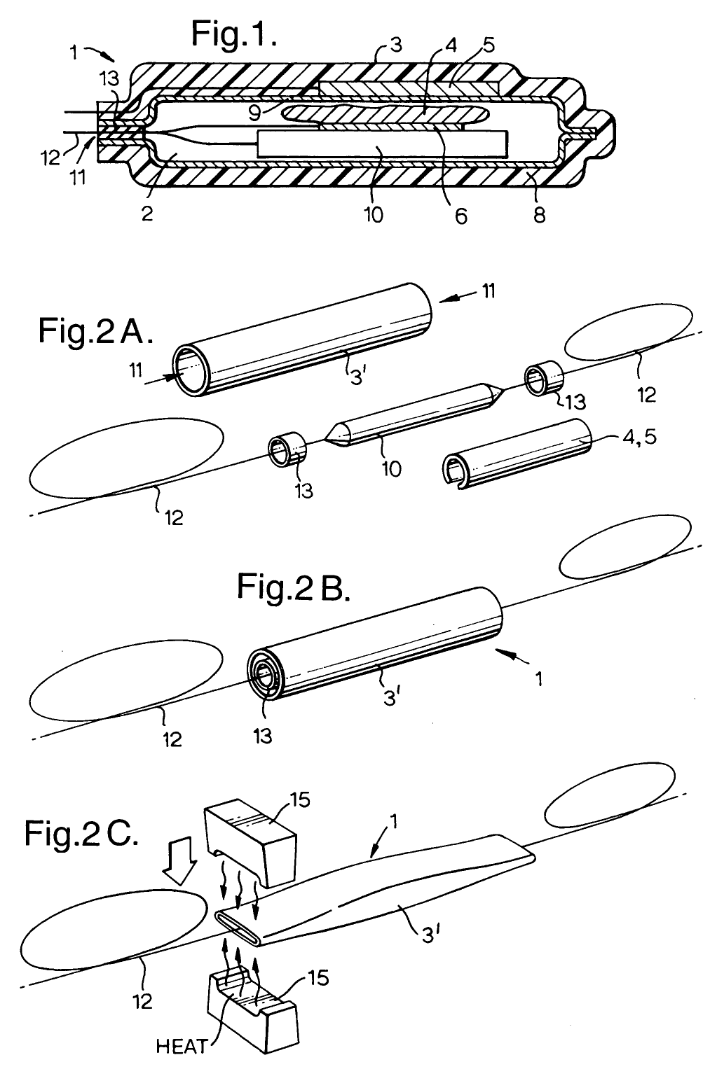

FIG. 1 schematically shows, in cross-sectional view, a first embodiment of a device according to the present invention.

FIG. 2 schematically shows, in perspective, a second embodiment of a device according to the present invention.

The device 1 shown merely by way of non-limiting example in FIG. 1 comprises a flexible container 3 which is in the form of an envelope, enclosing a space 2. The walls of the container 3 are shown to consist of two layers, an outer insulating layer 8 and an inner moisture barrier layer 9. The insulating layer 8 is preferably made of polyethylene or polyurethane, while the moisture barrier layer 9 is preferably made of aluminium. These layers may form a laminate of the kind used in Raychem's TDUX™ products, as disclosed in EP 0 579 641 and other patents. When properly sealed, such a laminate has an extremely low water vapour transmission rate (WVTR).

The access opening 11 of the container 3 is sealed by sealing strips 13 which enclose optical fibres 12. An optical circuit 10 and a humidity control means 4 (preferably a desiccant) are accommodated in the space 2.

In accordance with the present invention the device is provided with at least one temperature control unit. In the embodiment shown, a first temperature control unit 5 is accommodated in the space 2 defined by the container 3 and a second temperature control unit 6 is accommodated in a cavity provided in a container wall 7.

Although two temperature control units 5, 6 are shown in FIG. 1, it is preferred that only a single temperature control unit is present in a device 1.

The temperature control units 5, 6 may be active or passive and may comprise a heat sink, a heat pipe, a Peltier element or other suitable heat control elements. In the case of active elements, electrical leads (not shown) are passed through the opening 11 and sealed by the sealing strips 13.

The embodiment of FIG. 2 is particularly suitable for small optical circuits consisting of only one or two components. In FIG. 2A, a single optical component 10 is enclosed by a relatively rigid container 3′ which is preferably constituted by a metal sleeve. The strips 13, which are preferably made of a polymer, are bent in a ring-shape so as to seal both ends (openings 11) of the container 3′. A humidity and/or temperature control unit 4, 5 is approximately tubularly shaped so as to fit around the optical component 10. Optical fibres 12 are connected to the optical component 10. When the device 1 is assembled, the strips 13 are located near the ends of the container 3′, as shown in FIG. 2B. Then heat is applied to the end regions, as shown in FIG. 2C, to seal the device 1. To this end, suitable heat-generating dies 15 are used which are pressed together to effect the seal.

It will be understood by those skilled in the art that the present invention is not limited to the embodiments shown and that many additions and modifications are possible without departing from the scope of the present invention as defined in the appending claims.

1. A device for sealingly enclosing at least one optical circuit, the device comprising a container and a humidity control means accommodated in the container, and
temperature control means arranged in the container.

2. A device according to claim 1, wherein the container is substantially flexible.

3. A device according to claim 1, wherein the container is substantially rigid.

4. A device according to claim 1, wherein the temperature control means are accommodated in a wall of the container.

5. A device according to claim 1, wherein the temperature control means are accommodated in a space defined by the container.

6. A device according to claim 5, wherein the temperature control means are accommodated between the at least one optical component and a humidity control means.

7. A device according to claim 1, wherein the temperature control means comprise an active temperature controller.

8. A device according to claim 1, wherein the temperature control means comprise a heat sink.

9. A device according to claim 1, wherein the container comprises a heat insulating layer and a moisture barrier layer.

10. A device according claim 1, having an opening for feeding optical fibres therethrough, said opening being sealed by sealing strips to which heat and/or pressure is applied, said sealing strips preferably being made of plastic.

11. A device according to claim 1, wherein at least one optical circuit is accommodated, said circuit comprising active and/or passive optical components.

12. A device according to claim 1, wherein the at least one optical circuit comprises a single optical component.

13. A kit-of-parts for forming the device of claim 1.

14. A method of sealingly enclosing at least one optical circuit, the method comprising:
providing a container;
providing a humidity control means;
providing a temperature control means; and
accommodating the at least one circuit, the humidity control means and the temperature control means in the container.

15. A method according to claim 14, wherein the temperature control means is pre-installed in the container.

16. A method according to claim 14, wherein the temperature control means comprises a heat sink.

17. A method Met according to claim 14, wherein the container is substantially flexible.
